(19) United States
(12) Patent Application Publication
(10) Pub. No.: US 2010/0029263 A1
(43) Pub. Date: Feb. 4, 2010

(54) COGNITIVE RADIO SYSTEM, COGNITIVE RADIO APPARATUS, MANAGEMENT SERVER, COGNITIVE RADIO METHOD AND RECORDING MEDIUM

(75) Inventors: Hiroaki SENOO, Kawasaki (JP); Eiji Fujita, Fukuoka-shi (JP); Eizou Ishizu, Fukuoka-shi (JP); Masahiro Tanaka, Fukuoka-shi (JP); Hiroshi Towata, Fukuoka-shi (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/511,455

(22) Filed: Jul. 29, 2009

(30) Foreign Application Priority Data
Jul. 31, 2008 (JP) 2008-198491

(51) Int. Cl. H04W 24/00; H04W 72/00

(52) U.S. Cl. 455/423; 455/450

(57) ABSTRACT

A cognitive radio system includes cognitive radio apparatuses and a management server via a network.

The cognitive radio apparatus includes a terminal communication part selecting a communication protocol, a communication quality acquisition part acquiring a communication quality including a current location of the selected protocol, and a communication quality notification part notifying the server of the information.

The server includes a server communication part communicating with the apparatus, a communication quality collecting part collecting the information, a communication quality managing part recording and managing the information, and an area communication condition providing part providing the information to the apparatus.

### CROSS-REFERENCE TO RELATED APPLICATIONS

This application is based upon and claims the benefit of priority of the prior Japanese Patent Application No. 2008-198491, filed on Jul. 31, 2008, the entire contents of which are incorporated herein by reference.

### FIELD

The embodiment discussed herein relates to a cognitive radio system that includes a cognitive radio apparatus that enables one communication protocol to be selected among a plurality of different communication protocols to enable cognitive radio, and a management server that manages the cognitive radio apparatus; a cognitive radio apparatus; a management server; a cognitive radio guidance method; and a recording medium storing a computer-readable program for causing a computer to function as a cognitive radio system.

### BACKGROUND

In recent years, in accompaniment with the diversification and pluralization of cognitive radio systems and also with the spread of mobile telephones, there has been a shortage mainly of radio resources such as usable frequency bands. Cognitive radio systems are being actively researched and developed as a way of effectively utilizing limited radio resources.

A cognitive radio system is a system where a cognitive radio apparatus or a radio base station checks the surrounding radio wave conditions and, depending on the radio wave conditions, switches frequency channels or radio systems and performs communication without making the user aware of the switch. Thus, when this system is utilized, the cognitive radio apparatus may switch to a better radio system automatically when the area in the radio system that the cognitive radio apparatus is utilizing becomes congested such that communication quality deteriorates or even when the cognitive radio apparatus finds an area in a radio system that is better than the current condition.

Consequently, a cognitive radio system may realize switching even in the different radio systems of Worldwide Interoperability for Microwave Access (WiMax) and wireless local area networks (LAN) from communication using the radio waves of mobile telephones.

Cognitive radio systems may be broadly classified into two types of systems.

The first is a method being reviewed by the 11.22 WG (Working Group) of the IEEE (Institute of Electrical and Electronics Engineers, Inc.) that utilizes unused radio bands and unused time of already licensed cognitive radio systems (television broadcasting, satellite communications, aeronautical radio) to reduce the affect of interference on already licensed radio systems and effectively utilize the same bands as already licensed radio systems (see Japanese Laid-open Patent Publication No. 2007-88940).

The second is a method that holds, in a cognitive radio apparatus, a plurality of physical layer functions of the WiMax which is standard norm of IEEE 802.16e and the wireless LAN of IEEE 11.a to select and determine a radio system of a connection destination based on received radio information (interference levels, received power averages, in-use radio channels). (see Japanese Laid-open Patent Publication No. 2005-512423).

A cognitive radio system of this cognitive radio system may improve communication quality after selecting a radio channel by combining an unused radio channel selection control function with optimizing control of radio parameters based on geographical information, time information, and application information.

### SUMMARY

It is an aspect of the embodiments discussed herein to provide a cognitive radio system including at least one cognitive radio apparatus and a management server communicable with the at least one cognitive radio apparatus via a network.

The cognitive radio apparatus includes a terminal communication part that selects a communication protocol for communication among a plurality of communication protocols, a communication quality acquisition part that acquires a communication quality by receiving a current location of the cognitive radio apparatus and information of the selected communication protocol, and a communication quality notification part that notifies the management server via the terminal communication part of the current location of the cognitive radio apparatus and the communication quality.

The management server includes a server communication part that communicates with the cognitive radio apparatus, a communication quality collecting part that sequentially collects, from the cognitive radio apparatus via the server communication part, the current location of the cognitive radio apparatus and the communication quality, a communication quality managing part that records and manages the communication quality collected by the communication quality collecting part with respect to each location and each communication protocol, and an area communication condition providing part that provides an area communication condition to the cognitive radio apparatus, wherein the area communication condition includes any communication qualities for the current location of the cognitive radio apparatus and its area.

The object and advantages of the embodiment discussed herein will be realized and attained by means of elements and combinations particularly pointed out in the claims.

It is to be understood that both the foregoing general description and the following detailed and the following detailed description are exemplary and only are not restrictive exemplary explanatory are not restrictive of the invention, as claimed.

### BRIEF DESCRIPTION OF THE DRAWINGS

FIG. 1 is an explanatory diagram depicting a general configuration of an entire cognitive communication protocol of an embodiment of the present invention;

FIG. 2 is a block diagram depicting one example of the general configuration of the inside of a cognitive radio apparatus;

FIG. 3 is one example of an explanatory diagram simply depicting the relationship between received power and frequency of a communication protocol A and a communication protocol B;

FIG. 4 is one example of an explanatory diagram simply depicting the configuration of data inside current location communication quality information;

FIG. 5 is a block diagram depicting one example of the general configuration of the inside of a management server;

FIG. 6 is an explanatory diagram simply depicting an example of a received power average map that is managed in a communication quality managing part;

FIG. 7 is an explanatory diagram simply depicting an example of transformation curves for acquiring predicted data rates of the communication protocol A and the communication protocol B from received power averages of the communication protocol A and the communication protocol B;

FIG. 8 is an explanatory diagram simply depicting one example of cognitive radio guidance information that is displayed on a display part of the cognitive radio apparatus;

FIG. 9 is a sequence diagram depicting one example of a processing operation inside the cognitive communication protocol of current location communication quality information collection processing;

FIG. 10 is a sequence diagram depicting one example of a processing operation inside the cognitive communication protocol of cognitive radio guidance information provision processing;

FIG. 11 is a sequence diagram depicting one example of a processing operation inside the cognitive radio apparatus of current location communication quality information notification processing; and

FIG. 12 is a sequence diagram depicting one example of a processing operation inside the cognitive radio apparatus of cognitive radio guidance information display processing.

### DESCRIPTION OF THE EMBODIMENTS

Below, an embodiment of a cognitive radio system, a cognitive radio apparatus, a management server, a cognitive radio guidance method and a computer-readable recording medium storing a cognitive radio guidance program for causing a computer to function as the cognitive radio system will be described in detail based on the drawings. The embodiment of the cognitive radio system will be described using an example applied to a cognitive radio system employing the second type of a cognitive communication protocol.

First, the synopsis of the embodiments is sequentially collecting a current location of a cognitive radio apparatus and a communication quality of each communication system from the cognitive radio apparatus and managing, in a management server, the communication quality per location in each communication protocol based on the current location of the cognitive radio apparatus and the communication quality of each cognitive radio protocol.

Moreover, when the management server receives a given request command from the cognitive radio apparatus, the management server reads, from a communication quality managing part, a surrounding region, which includes the current location of the cognitive radio apparatus, and the communication quality of each communication protocol corresponding to each location in the surrounding region. The management server also provides a surrounding reception condition, which includes the read surrounding region of the cognitive radio apparatus and the communication quality of each communication protocol, to the cognitive radio apparatus that issued the given request command.

Then, when the cognitive radio apparatus receives the surrounding reception condition, the cognitive radio apparatus generates cognitive radio guidance information guiding selection of an optimum communication protocol for each location in the surrounding region based on the surrounding reception condition. The cognitive radio apparatus also displays the cognitive radio guidance information on a display screen.

The user of the cognitive radio apparatus may know a radio state, for example, spatial use conditions of radio channels and communication protocols and interference conditions, of each communication protocol in the surrounding region including the current location based on the cognitive radio guidance information displayed on the display screen. As a result, the user may select an optimum broadband communication protocol and a radio channel.

Moreover, the management server may manage the communication quality of each location in a communication protocol by sequentially collecting the communication quality of each communication protocol per current location from each of the cognitive radio apparatuses. The management server may provide the cognitive radio apparatus with the surrounding reception condition needed for the cognitive radio apparatus to generate the cognitive radio guidance information prompting the selection guidance of the optimum communication protocol.

Moreover, the user of the cognitive radio apparatus is prompted to move in order to select the communication protocol with a low load based on the cognitive radio guidance information on the display screen. Thereby, the load on the network of the entire communication protocol may be alleviated, and the utilization efficiency of the spatial frequency channels on a time axis and a frequency axis may be improved.

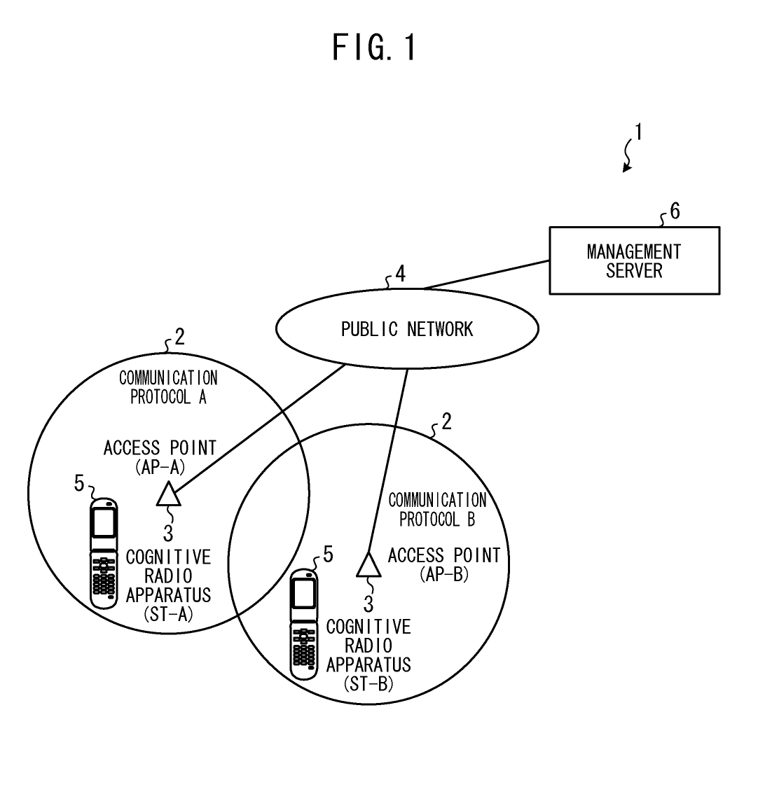

FIG. 1 is an explanatory diagram depicting, as one example of the general configuration of an entire cognitive communication system 1 of the present embodiment, an overview thereof.

The cognitive communication protocol 1 depicted in FIG. 1 includes radio areas 2 among a plurality of different communication protocols, a public network 4 that interconnects access points 3 in each of the radio areas 2 to interconnect the communication protocols, and a management server 6 that is connectable to the public network 4 and manages cognitive radio apparatuses 5 that wirelessly access the access points 3.

In the cognitive communication protocol 1 depicted in FIG. 1, there are radio areas 2 of two types of communication protocols “A” and “B”, with AP-A representing the access point 3 in communication protocol A and AP-B representing the access point 3 in communication protocol B.

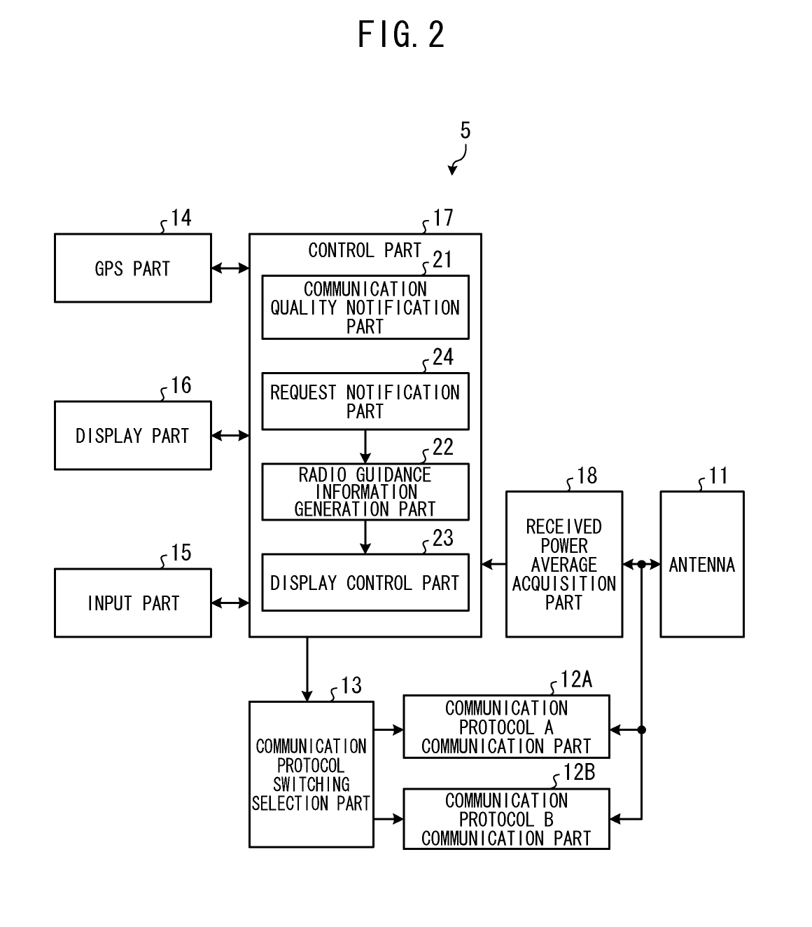

FIG. 2 is a block diagram depicting one example of the general configuration of the inside of the cognitive radio apparatus 5.

The cognitive radio apparatus 5 depicted in FIG. 2 corresponds to a cognitive radio apparatus that enables communication in a different communication protocol to be selected. The cognitive radio apparatus 5 includes an antenna 11 that transmits and receives radio signals via the access points 3 in each of the communication protocols. A communication protocol A communication part 12A establishes wireless communication with the communication protocol A via the antenna 11. A communication protocol B communication part 12B establishes wireless communication with the communication protocol B via the antenna 11.

The cognitive radio apparatus 5 also includes a communication protocol switching selection part 13 including both the communication protocol A communication part 12A and the communication protocol B communication part 12B, a global positioning system part 14, an input part 15, and a display part 16. The communication protocol switching selection part 13 switches between the communication protocol A communication part 12A and the communication protocol B communication part 12B and selects either the communication protocol A communication part 12A or the communication protocol B communication part 12B. The global positioning system (hereinafter simply called “GPS”) part 14 acquires the current location of the cognitive radio apparatus 5. The input part 15 inputs various information. The display part 16 displays various information

The GPS part 14 uses artificial satellites to acquire the current location of the cognitive radio apparatus 5 based on longitude information and latitude information. Further, the cognitive radio apparatus 5 may also acquire the current location (longitude information and latitude information) of the cognitive radio apparatus 5 from notice information from the access points 3.

Further, the cognitive radio apparatus 5 also includes a control part 17 and a received power average acquisition part 18. The control part 17 controls the entire cognitive radio apparatus 5 and executes applications inside the cognitive radio apparatus 5. The received power average acquisition part 18 measures the received power of the access points 3 of all radio channels in the communication protocol currently being used to acquire the average of the measurement results as a received power average.

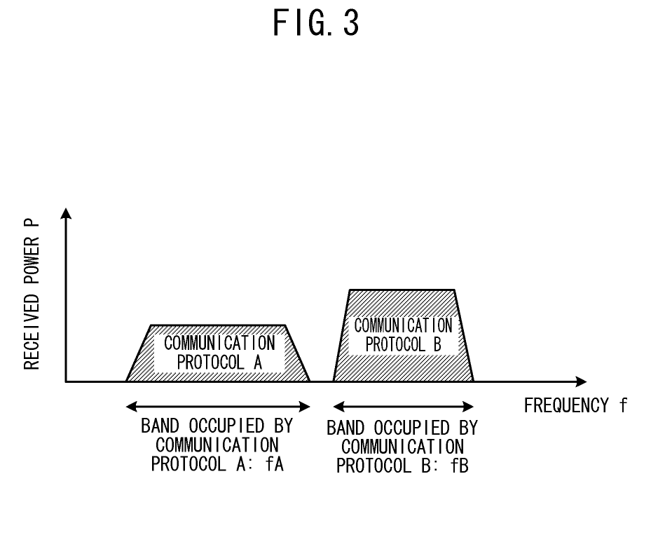

FIG. 3 is one example of an explanatory diagram depicting the relationship between received power and frequency of the communication protocol A and the communication protocol B.

A received average power PA of the communication protocol A is, as depicted in FIG. 3, calculated using the formula PA=(ΣPn)/fA. “fA” represents the band occupied by the communication protocol A and “n” represents the number of radio channels from the smallest frequency to the largest frequency in the band fA.

Further, a received average power PB of the communication protocol B is, as depicted in FIG. 3, calculated using the formula PB=(ΣPn)/fB. “fB” represents the band occupied by the communication protocol B and “n” represents the number of radio channels from the smallest frequency to the largest frequency in the band fB.

The control part 17 includes a communication quality notification part 21. The communication quality notification part 21 holds the received power average at the current location acquired by the received power average acquisition part 18. The communication quality notification part 21 notifies the management server 6, via the access point 3 and the public network 4, of current location communication quality information 30 including the current location of the cognitive radio apparatus 5 and the received power average at the current location.

Moreover, the control part 17 also includes a cognitive radio guidance information generation part 22, a display control part 23, cognitive radio guidance information, and a request notification part 24. The cognitive radio guidance information generation part 22 generates later-described cognitive radio guidance information. The display control part 23 displays the generated cognitive radio guidance information on a screen of the display part 16. The request notification part 24 notifies the management server 6 of a surrounding reception condition request to request information including the surrounding reception condition in order to generate the cognitive radio guidance information.

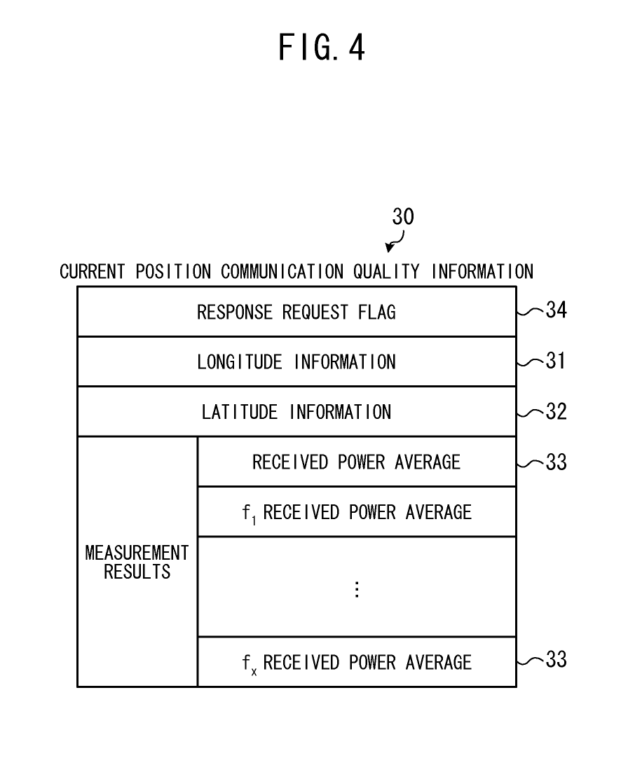

FIG. 4 is one example of an explanatory diagram depicting the configuration of data inside the current location communication quality information 30.

The current location communication quality information 30 is information of which the management server 6 is notified through the communication quality notification part 21 of the cognitive radio apparatus 5. The current location communication quality information 30 includes longitude information 31 and latitude information 32 representing the current location of the cognitive radio apparatus 5, a received power average 33 of each radio channel in use of the communication protocol A and the communication protocol B, and a response request flag 34.

The response request flag 34 is set to ON when the request notification part 24 requests the surrounding reception condition from the management server 6 in accordance with the management server 6 notified of the current location communication quality information 30. The response request flag 34 is set to OFF when the communication quality notification part 21 only notifies the management server 6 of the current location communication quality information 30 and the request notification part 24 does not request the surrounding reception condition from the management server 6.

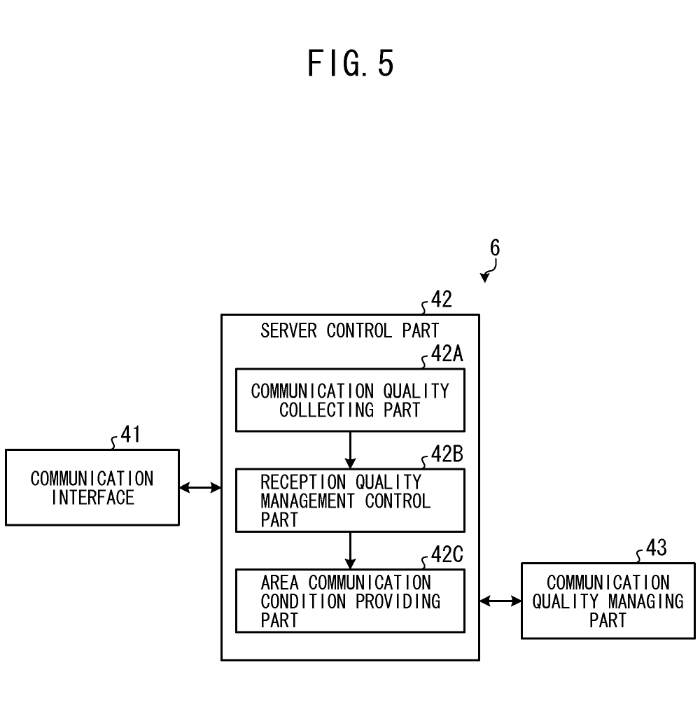

FIG. 5 is a block diagram depicting one example of the general configuration of the inside of the management server 6.

The management server 6 depicted in FIG. 5 includes a communication interface 41 and a server control part 42. The communication interface 41 is responsible for communicably interfacing with the public network 4. The server control part 42 controls the entire management server 6.

The server control part 42 includes a communication quality collecting part 42A. When the communication quality collecting part 42A sequentially receives the current location communication quality information 30 from each of the cognitive radio apparatuses 5 in the cognitive communication protocol 1, the communication quality collecting part 42A sequentially collects the current location communication quality information 30.

The server control part 42 also includes a communication quality management control part 42B. The communication quality management control part 42B updates and controls a communication quality managing part 43. The communication quality managing part 43 manages the current location communication quality information 30 that has been collected by the communication quality collecting part 42A.

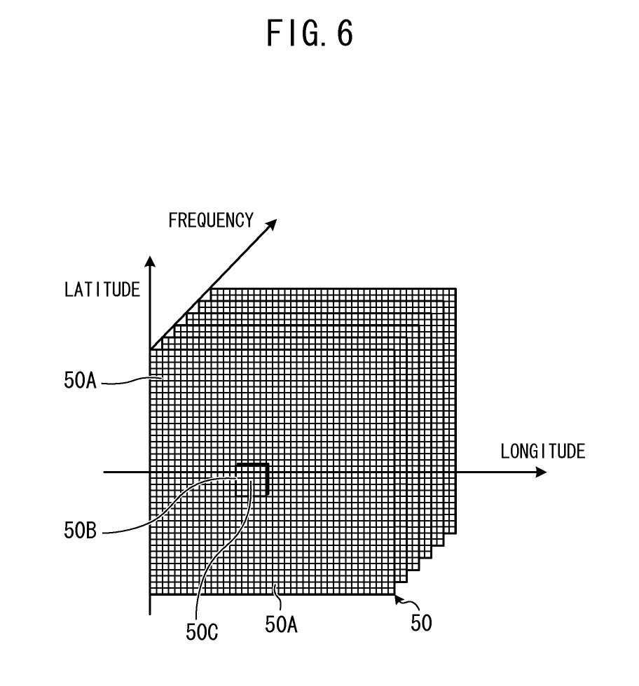

The communication quality managing part 43 manages a received power average map 50 for each communication protocol. FIG. 6 is one example of an explanatory diagram depicting the received power average map 50. The received power average map 50 manages the received power averages per location in the areas of the communication protocol A and the communication protocol B.

The single received power average map 50 depicted in FIG. 6 has an X axis representing longitude and a Y axis representing latitude. The single received power average map 50 depicts locations by single squares 50A on a grid, and manages received power averages and last update times per location.

Every time the communication quality collecting part 42A collects the current location communication quality information 30 from the cognitive radio apparatuses 5 in the communication protocol A and the communication protocol B, the communication quality management control part 42B updates the received power average and the last update time of the location corresponding to the current location of the same cognitive radio apparatuses 5 on the received power average map 50. In an initial state, as for the received power averages of each location on the received power average map 50, the communication quality management control part 42B may store initial values of received power averages set beforehand.

Every time the communication quality collecting part 42A collects the current location communication quality information 30, the communication quality management control part 42B updates the received power average of the location corresponding to the same current location based on the current location communication quality information 30. The communication quality collecting part 42A also updates the last update time.

At that time, when the communication quality management control part 42B updates the received power average at the current location in the current location communication quality information 30 to a received power average corresponding to the same current location on the received power average map 50, managed in the communication quality managing part 43, the communication quality management control part 42B performs weighted addition based on a given condition, that is, based on the difference between the current time and the last update time.

For example, the communication quality management control part 42B emphasizes a received power average at this time when about three hours have elapsed since the last update time. The communication quality management control part 42B updates the received power average to a received power average corresponding to the same current location being managed in the communication quality managing part 43.

Further, when about three minutes have elapsed since the last update time, for example, the communication quality management control part 42B emphasizes and updates the received power average by an average of the received power average corresponding to the same current location being managed in the communication quality managing part 43 and the power average received at the current time. In other words, the communication quality management control part 42B includes configuration to change the degree of updating of the received power averages depending on the length of elapsed time from the last update time to the current time. The received power averages return to their initial values when a given length of time has been reached since the last update time.

Further, the server control part 42 depicted in FIG. 5 also includes a surrounding reception condition providing part 42C. When the surrounding reception condition providing part 42C receives a surrounding reception condition request from one of the cognitive radio apparatuses 5, the surrounding reception condition providing part 42C provides, to the cognitive radio apparatus 5 that issued the surrounding reception condition request, a surrounding reception condition including the received power averages corresponding to each location of a surrounding region 50B including a current location 50C of the cognitive radio apparatus 5 on the received power average map 50 depicted in FIG. 6.

When the surrounding reception condition providing part 42C receives a surrounding reception condition request, the surrounding reception condition providing part 42C reads, from the communication quality managing part 43, the received power averages corresponding to each location of a surrounding region 50B. The surrounding region 50B includes the current location 50C of the cognitive radio apparatus 5 in the current location communication quality information 30 of the cognitive radio apparatus 5 accompanying the surrounding reception condition request. The surrounding region 50B provides, to the cognitive radio apparatus 5 via the communication interface 41, the surrounding reception condition including the surrounding region 50B of the cognitive radio apparatus 5 and the communication quality for each communication protocol that the surrounding reception condition providing part 42C has read.

Further, the request notification part 24 in the control part 17 of the cognitive radio apparatus 5 depicted in FIG. 2 notifies, in response to request operation of the input part 15, the management server 6 of the current location communication quality information 30 whose response request flag 34 is set to ON.

When the surrounding reception condition providing part 42C of the management server 6 receives the surrounding reception condition, the cognitive radio guidance information generation part 22 generates cognitive radio guidance information guiding selection of the optimum broadband communication protocol of each location in the surrounding region based on predicted data rates per communication protocol with respect to the received power averages in the communication quality for each communication protocol of the surrounding region in the surrounding reception condition.

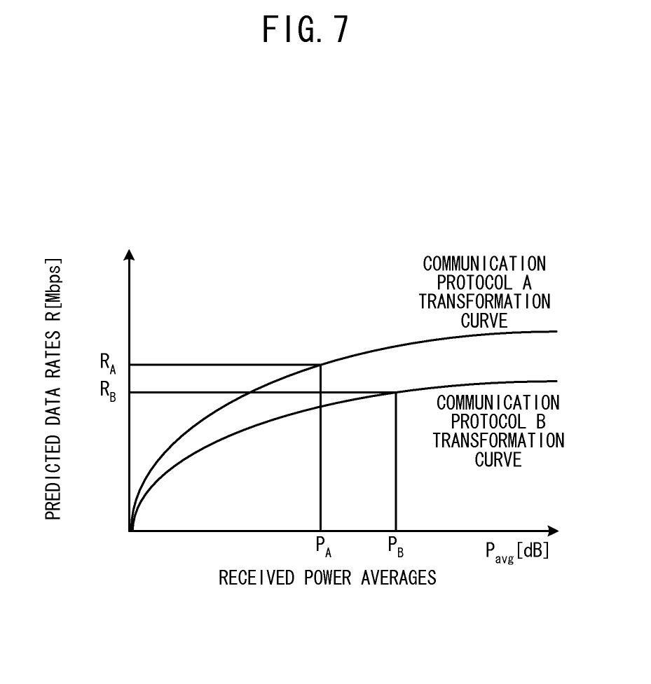

FIG. 7 is an explanatory diagram depicting transformation curves for acquiring predicted data rates of the communication protocol A and the communication protocol B from the received power averages of the communication protocol A and the communication protocol B.

When the cognitive radio guidance information generation part 22 acquires the received power averages for each cognitive communication protocol of each location in the surrounding region in the surrounding reception condition, the cognitive radio guidance information generation part 22 acquires a predicted data rate of the communication protocol A of the same location corresponding to the received power average of the communication protocol A of the same location in accordance with the transformation curve of the communication protocol A depicted in FIG. 7.

Further, when the cognitive radio guidance information generation part 22 acquires the received power averages for each communication protocol of each location in the surrounding region in the surrounding reception condition, the cognitive radio guidance information generation part 22 acquires a predicted data rate of the communication protocol B of the same location corresponding to the received power average of the communication protocol B of the same location in accordance with the transformation curve of the communication protocol B depicted in FIG. 7.

Moreover, the cognitive radio guidance information generation part 22 compares the predicted data rate of the communication protocol A of the same location with the predicted data rate of the communication protocol B and selects the optimum broadband communication protocol at the same location based on the comparison result.

The cognitive radio guidance information generation system 22 selects the optimum communication protocol per location in the surrounding region in the surrounding reception condition. The cognitive radio guidance information generation system 22 synthesizes the selected optimum cognitive communication protocols per location to generate cognitive radio guidance information in the surrounding region including the current location of the cognitive radio apparatus 5.

When the cognitive radio guidance information generation part 22 generates the cognitive radio guidance information corresponding to the surrounding region, the display control part 23 displays the cognitive radio guidance information on the screen of the display part 16.

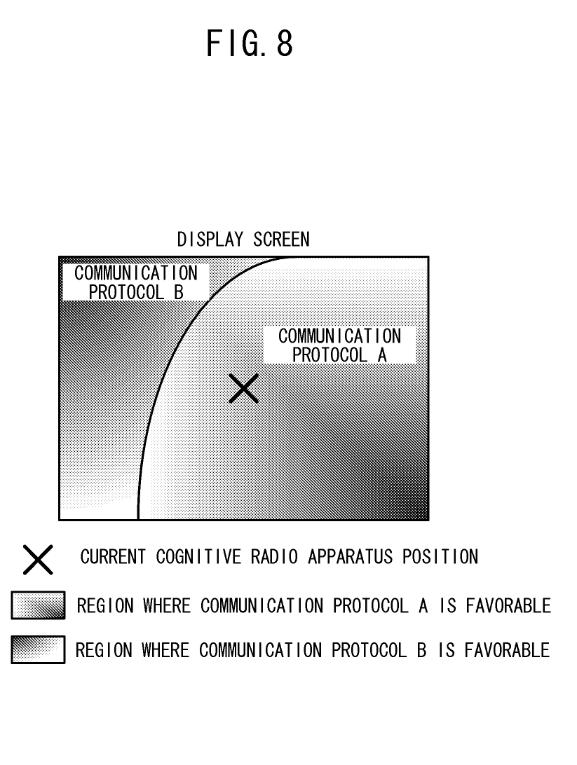

FIG. 8 is an explanatory diagram depicting one example of the cognitive radio guidance information that is displayed on the display part 16 of the cognitive radio apparatus 5.

In the cognitive radio guidance information displayed on the display part 16 depicted in FIG. 8, “x” represents the current location of the cognitive radio apparatus 5. Light and dark represent the predicted data rates of the communication protocols in each location of the surrounding region from the current location. As a result, the predicted data rates become lower the lighter that the color becomes and the predicted data rates become higher the darker that the color becomes.

By viewing the cognitive radio guidance information displayed on the display part 16, the user of the cognitive radio apparatus 5 may recognize the place and direction where the optimum broadband communication protocol of the predicted data rate may be obtained from the current location of the user by moving in the direction where the color on the display screen is darker, for example.

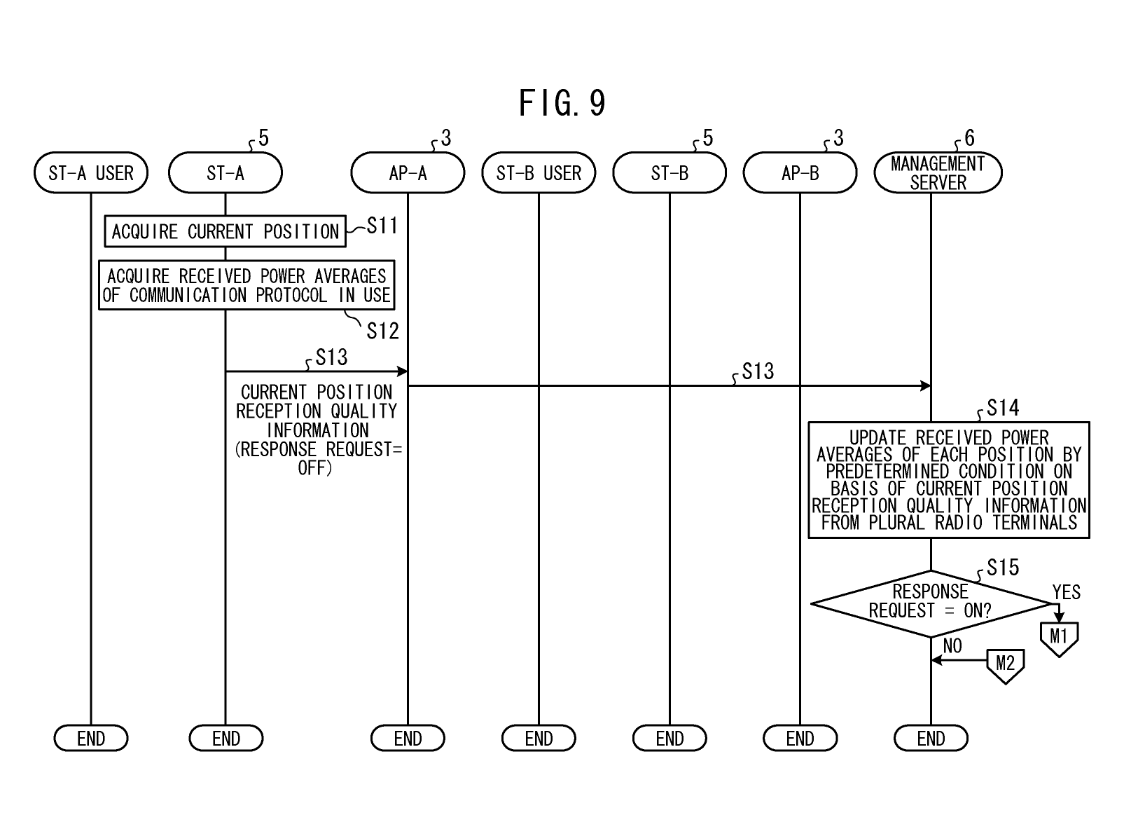

Next, the operation of the cognitive communication protocol 1 of the present embodiment will be described. FIG. 9 is a sequence diagram depicting one example of a processing operation inside the cognitive communication protocol 1 of current location communication quality information collection processing.

For example, if the cognitive radio apparatus 5 (ST-A) is selecting the communication protocol A, when the cognitive radio apparatus 5 acquires its current location from the GPS part 14 or the access point 3 (AP-A) (at operation S11), the cognitive radio apparatus 5 (ST-A) acquires the received power averages of the communication protocol A of the radio channels in use through the received power average acquisition part 18 (at operation S12).

When the cognitive radio apparatus 5 (ST-A) acquires the received power averages of the communication protocol A of the current location, the cognitive radio apparatus 5 (ST-A) notifies the management server 6, via the access point 3 (AP-A) and the public network 4, of the current location communication quality information 30 including the current location of the cognitive radio apparatus 5 (ST-A) and the received power averages of the communication protocol A (at operation S13). At this time, the response request flag 34 in the current location communication quality information 30 is placed in the OFF setting.

Then, in the management server 6, when the communication quality collecting part 42A sequentially collects the current location communication quality information 30 from the cognitive radio apparatus 5 via the communication interface 41, the communication quality management control part 42B sequentially updates, in accordance with the given condition, the current location and the current received power averages in the current location communication quality information 30 to the received power averages being managed in the communication quality managing part 43 corresponding to the same current location (at operation S14). As mentioned before, the given condition corresponds to successive updating of the received power averages based on the difference between the current time and the last update time.

Moreover, when the management server 6 collects the current location communication quality information 30 from the cognitive radio apparatus 5, the management server 6 determines whether or not the response request flag 34 in the current location communication quality information 30 is in the ON setting (at operation S15).

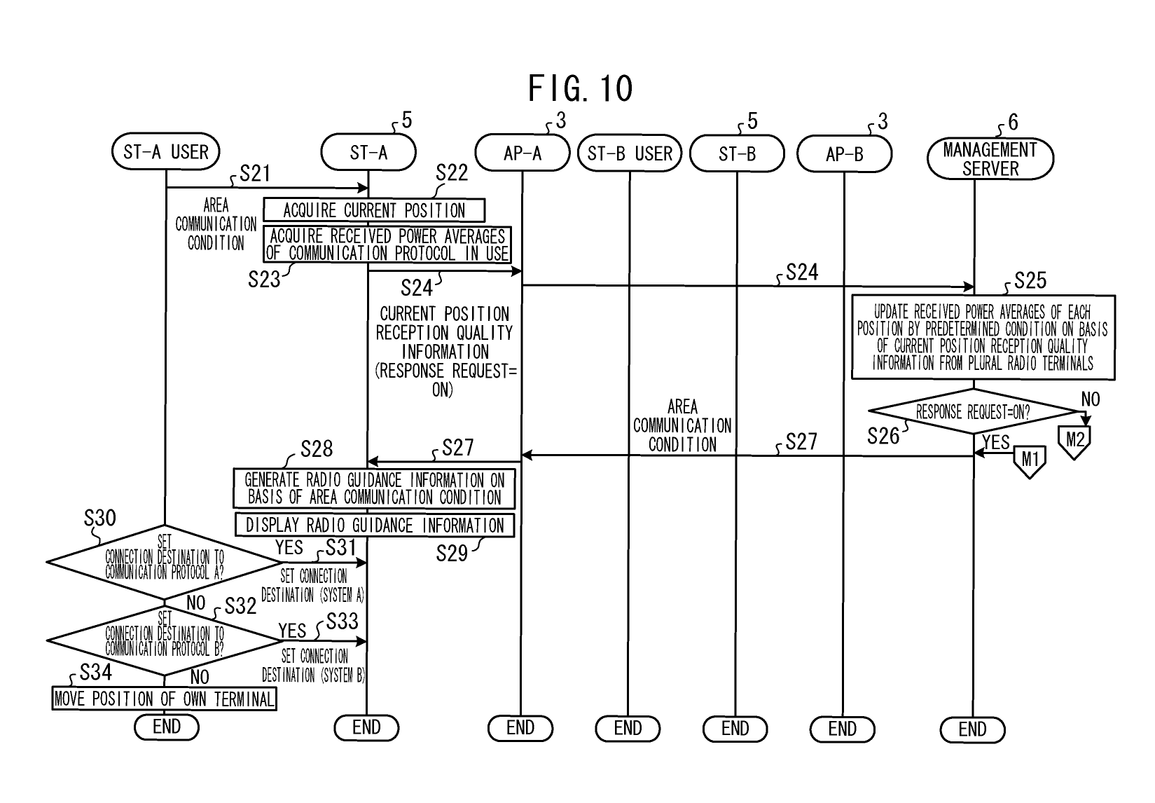

When the response request flag 34 in the current location communication quality information 30 is in the ON setting (at operation S15: YES), the management server 6 moves to M1 depicted in FIG. 10.

Further, when the response request flag 34 in the current location communication quality information 30 is not in the ON setting (at operation S15: NO), the management server 6 judges that the response request flag 34 is in the OFF setting and ends the processing operation depicted in FIG. 9.

For the sake of convenience, an example has been described where the cognitive radio apparatus 5 (ST-A) selects the communication protocol A and notifies the management server 6 of the current location communication quality information 30. But when, for example, the cognitive radio apparatus 5 (ST-A) is selecting the communication protocol B, even when the cognitive radio apparatus 5 (ST-A) acquires its current location from the GPS part 14 or the access point 3 (AP-B), acquires the received power averages of the communication protocol B of the radio channels in use through the received power average acquisition part 18, and also notifies the management server 6, through the communication quality notification part 21 via the access point 3 (AP-B) and the public network 4, of the current location communication quality information 30 including the current location of the cognitive radio apparatus 5 (ST-A) and the received power averages of the communication protocol B, the management server 6 similarly updates, in accordance with the given condition, the received power averages managed in the communication quality managing part 43 corresponding to the same current location based on the current location communication quality information 30.

Further, similarly, when the cognitive radio apparatus 5 (ST-B) is selecting the communication protocol B, even when the cognitive radio apparatus 5 (ST-B) acquires its current location from the GPS part 14 or the access point 3 (AP-B), acquires the received power averages of the communication protocol B of the radio channels in use through the received power average acquisition part 18, and also notifies the management server 6, through the communication quality notification part 21 via the access point 3 (AP-B) and the public network 4, of the current location communication quality information 30 including the current location of the cognitive radio apparatus 5 (ST-B) and the received power averages of the communication protocol B, the management server 6 similarly updates, in accordance with the given condition, the received power averages managed in the communication quality managing part 43 corresponding to the same current location based on the current location communication quality information 30.

In the current location communication quality information collection processing depicted in FIG. 9, the communication quality collecting part 42A sequentially collects the current location communication quality information 30 from each of the cognitive radio apparatuses 5 of the communication protocol A and the communication protocol B. Whereby the communication quality managing part 43 sequentially updates, in accordance with the given condition, the received power averages for each communication protocol being managed by the communication quality managing part 43 of the management server 6, so the communication quality managing part 43 manages the most recent received power averages per location of the communication protocol A and the communication protocol B based on the current location communication quality information 30 from each of the cognitive radio apparatuses 5.

FIG. 10 is a sequence diagram depicting one example of a processing operation inside the cognitive communication protocol 1 of cognitive radio guidance information provision processing.

When the cognitive radio apparatus 5 (ST-A) depicted in FIG. 10 detects the surrounding reception condition of the user of the cognitive radio apparatus 5 (ST-A) through the input part 14 (at operation S21), if the cognitive radio apparatus 5 (ST-A) is selecting the communication protocol A, the cognitive radio apparatus 5 (ST-A) acquires its current location from the GPS part 14 or the access point 3 (AP-A) (at operation S22). The cognitive radio apparatus 5 also acquires the received power averages of the communication protocol A of the radio channels in use through the received power average acquisition part 18 (at operation S23).

When the cognitive radio apparatus 5 (ST-A) acquires the received power averages of the communication protocol A of the current location, the cognitive radio apparatus 5 (ST-A) notifies the management server 6, via the access point 3 (AP-A) and the public network 4, of the current location communication quality information 30. The current location communication quality information 30 includes the current location of the cognitive radio apparatus 5 (ST-A) and the received power averages of the communication protocol A (at operation S24). At this time, the response request flag 34 in the current location communication quality information 30 is placed in the ON setting.

Then, in the management server 6, when the communication quality collecting part 42A sequentially collects the current location communication quality information 30 from the cognitive radio apparatus 5 via the communication interface 41, the communication quality management control part 42B sequentially updates, in accordance with the given condition, the current location and the received power averages in the current location communication quality information 30 to the received power averages. The received power averages are managed in the communication quality managing part 43 corresponding to the same current location (at operation S25). The given condition corresponds to successive updating of the received power averages based on the aforementioned last update time.

Moreover, when the management server 6 collects the current location communication quality information 30 from the cognitive radio apparatus 5, the management server 6 determines whether or not the response request flag 34 in the current location communication quality information 30 is in the ON setting (at operation S26).

When the response request flag 34 in the current location communication quality information 30 is in the ON setting (at operation S26: YES), the surrounding reception condition providing part 42C of the management server 6 reads, from the communication quality managing part 43, the received power averages corresponding to each location in the surrounding region. The surrounding region includes the current location in the current location communication quality information 30. The surrounding reception condition providing part 42C provides, to the cognitive radio apparatus 5 (ST-A) via the access point 3 (AP-A), the surrounding reception condition including the surrounding region and the communication quality for each communication protocol that the surrounding reception condition providing part 42C has read (at an operation S27).

In the cognitive radio apparatus 5 (ST-A), when the cognitive radio guidance information generation part 22 receives the surrounding reception condition, the cognitive radio guidance information generation part 22 generates the cognitive radio guidance information guiding selection of the optimum communication protocol of each location in the surrounding region based on the surrounding reception condition (at operation S28). The display control part 23 displays the cognitive radio guidance information on the screen of the display part 16 (at operation S29).

The user of the cognitive radio apparatus 5 (ST-A) judges whether or not to set the connection destination to the communication protocol A based on the cognitive radio guidance information being displayed on the screen of the display part 16 (operation S30).

When the user of the cognitive radio apparatus 5 (ST-A) decides to set the connection destination to the communication protocol A (at operation S30: YES), the user of the cognitive radio apparatus 5 (ST-A) sets the connection destination of the cognitive radio apparatus 5 (ST-A) to the communication protocol A through the input part 14 (at operation S31).

Further, when the user of the cognitive radio apparatus 5 (ST-A) decides not to set the connection destination to the communication protocol A (at operation S30: NO), the user of the cognitive radio apparatus 5 (ST-A) judges whether or not to set the connection destination to the communication protocol B (at operation S32).

Further, when the user of the cognitive radio apparatus 5 (ST-A) decides to set the connection destination to the communication protocol B (at operation S32: YES), the user of the cognitive radio apparatus 5 (ST-A) sets the connection destination of the cognitive radio apparatus 5 (ST-A) to the communication protocol B through the input part 14 (at operation S33).

Further, when the user of the cognitive radio apparatus 5 (ST-A) decides not to set the connection destination to the communication protocol B (at operation S32: NO), the user of the cognitive radio apparatus 5 (ST-A) ends the processing operation depicted in FIG. 10 by moving the cognitive radio apparatus 5 from the current location (at operation S34).

Further, when the response request flag 34 in the current location communication quality information 30 is not in the ON setting (at operation S26: NO), the management server 6 moves to M2 depicted in FIG. 9.

The period until the user of the cognitive radio apparatus 5 (ST-A) sets the connection destination of the cognitive radio apparatus 5 (ST-A) to a communication protocol in operation S31 or operation S33 is preliminary communication for displaying the cognitive radio guidance information on the screen of the display part 16, and when the user of the cognitive radio apparatus 5 (ST-A) sets the connection destination to a communication protocol, the cognitive radio apparatus 5 (ST-A) uses the communication protocol to which it has been set and initiates actual communication.

In the cognitive radio guidance information provision processing depicted in FIG. 10, the communication quality notification part 21 notifies the management server 6 of the current location communication quality information 30 of the cognitive radio apparatus 5 in accordance with the surrounding reception condition request. In the management server 6, the communication quality management control part 42B updates, by the given condition, the received power averages for each communication protocol of the same location in the communication quality managing part 43 based on the current location communication quality information 30 from the cognitive radio apparatus 5. Thereafter, in the cognitive radio guidance information provision processing, the surrounding reception condition providing part 42C provides, to the cognitive radio apparatus 5, the surrounding reception condition for each communication protocol corresponding to the surrounding region including the current location of the cognitive radio apparatus 5 of the same surrounding reception condition request. Then, in the cognitive radio apparatus 5, when the cognitive radio guidance information generation part 22 receives the surrounding reception condition from the management server 6, the cognitive radio guidance information generation part 22 generates the cognitive radio guidance information guiding selection of the optimum communication protocol of each location in the surrounding region based on the predicted data rates per communication protocol corresponding to the received power averages in the communication quality for each communication protocol of each location of the surrounding region in the surrounding reception condition, and the display control part 23 displays the cognitive radio guidance information on the screen of the display part 16.

As a result, the user of the cognitive radio apparatus 5 may recognize the location of the optimum broadband communication protocol in the surrounding region including the current location based on the cognitive radio guidance information being displayed on the screen of the display part 16. Additionally, the cognitive radio apparatus 5 may shorten the length of time to download data by selecting the optimum broadband communication protocol.

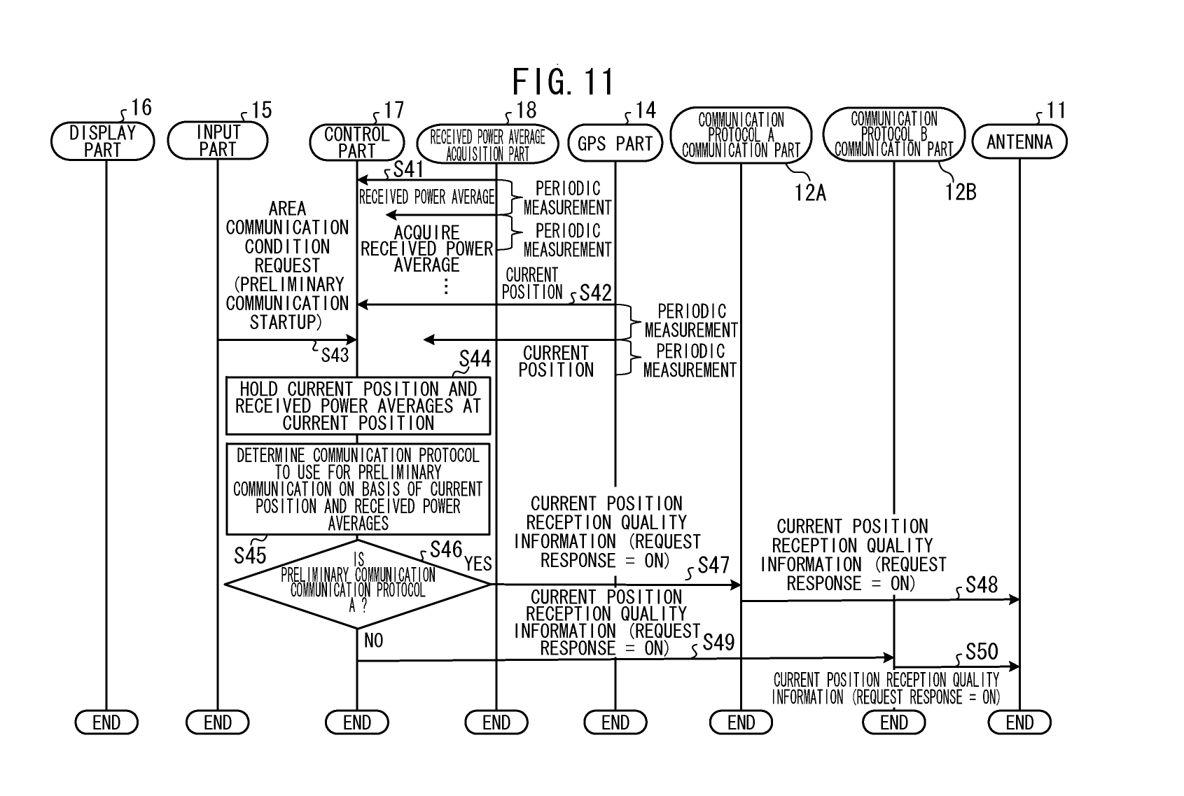

FIG. 11 is a sequence diagram depicting a processing operation inside the cognitive radio apparatus 5 of a current location communication quality information notification processing.

The current location communication quality information notification process depicted in FIG. 11 is a process for the cognitive radio apparatus 5 to notify the management server 6 of the current location communication quality information 30 that the cognitive radio apparatus 5 has acquired.

The received power average acquisition part 18 periodically acquires the received power averages of the communication protocol in use at the current location (at operation S41).

The control part 17 periodically acquires the current location through the GPS part 14 (at operation S42).

When the control part 17 detects preliminary communication startup accompanying a surrounding reception condition request through the input part 15 (at operation S43), the control part 17 holds the current location communication quality information 30 including the current location and the received power averages for each communication protocol at the current location acquired in operations S41 and S42 (at operation S44) and determines the communication protocol to be used for preliminary communication based on the current location and the received power averages for each communication protocol (at operation S45).

The control part 17 determines whether or not the communication protocol to be used for preliminary communication is the communication protocol A (at operation S46).

When the communication protocol to be used for preliminary communication is the communication protocol A (at operation S46: YES), the control part 17 notifies the communication protocol A communication part 12A of the current location communication quality information 30 (at operation S47). The current location communication quality information 30 is information whose response request flag 34 is set to ON.

Then, the communication protocol A communication part 12A ends the processing operation depicted in FIG. 11 by notifying the management server 6 of the current location communication quality information 30 via the access point 3 (AP-A) and the public network 4 through the antenna 11 (at operation S48).

Further, when the communication protocol to be used for preliminary communication is not the communication protocol A (at operation S46: NO), the control part 17 judges that the communication protocol B is the communication protocol to be used for preliminary communication and notifies the communication protocol B communication part 12B of the current location communication quality information 30 (at operation S49). The current location communication quality information 30 is information whose response request flag 34 is set to ON.

Then, the communication protocol B communication part 12B ends the processing operation depicted in FIG. 11 by notifying the management server 6 of the current location communication quality information 30 via the access point 3 (AP-B) and the public network 4 through the antenna 11 (at operation S50).

In the current location communication quality information notification processing depicted in FIG. 11, the cognitive radio apparatus 5 notifies the management server 6 of the current location communication quality information 30 that the cognitive radio apparatus 5 has acquired. For that reason, in the management server 6, the communication quality collecting part 42A may sequentially collect the current location communication quality information 30 from each of the cognitive radio apparatuses 5, and the communication quality managing part 43 may manage, for each communication protocol, the most recent received power averages per location in the entire area in the communication protocol A and the communication protocol B.

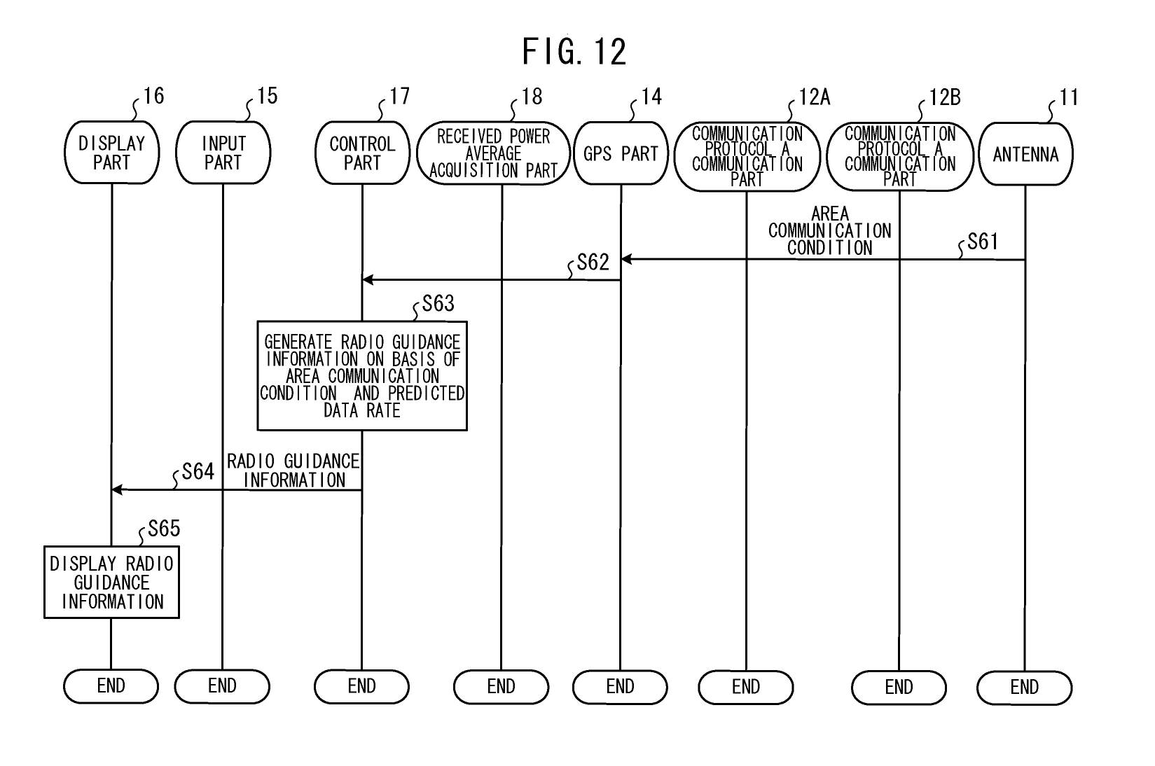

FIG. 12 is a sequence diagram depicting one example of a processing operation inside the cognitive radio apparatus 5 of cognitive radio guidance information display processing.

When the communication protocol A communication part 12A depicted in FIG. 12 receives the surrounding reception condition via the antenna 11 (at operation S61), the communication protocol A communication part 12A notifies the control part 17 of the surrounding reception condition (at operation S62).

When the control part 17 receives the surrounding reception condition, the cognitive radio guidance information generation part 22 generates the cognitive radio guidance information based on the predicted data rates corresponding to the received power averages per location in the surrounding reception condition (at operation S63), notifies the display part 16 of the cognitive radio guidance information through the display control part 23 (at operation S64), and displays the cognitive radio guidance information on the screen of the display part 16 (at operation S65). Whereby the control part 17 ends the processing operation of FIG. 12. The cognitive radio guidance information generation part 22 compares the predicted data rates for each communication protocol per location and displays the cognitive radio guidance information for the user of the cognitive radio apparatus 5 to select the optimum broadband communication protocol on the screen of the display part 16 based on the comparison results.

In the cognitive radio guidance information display processing depicted in FIG. 12, when the control part 17 receives the surrounding reception condition, the cognitive radio guidance information generation part 22 acquires the predicted data rates for each communication protocol corresponding to the received power averages for each communication protocol corresponding to each location in the surrounding reception condition, compares the predicted data rates for each communication protocols each other, and displays, on the screen of the display part 16, the cognitive radio guidance information guiding selection of the broadband optimum communication protocol based on the comparison results. For that reason, by viewing the cognitive radio guidance information, the user of the cognitive radio apparatus 5 may recognize the place and direction where the optimum broadband communication protocol of the predicted data rate may be obtained from the current location of the user by moving in the direction where the color on the display screen is darker, for example.

In the present embodiment, the user of the cognitive radio apparatus 5 may recognize and select the optimum broadband communication protocol and radio channel including the radio state of each communication protocol in the surrounding region including the current location, for example, spatial use conditions of radio channels and communication protocols and interference conditions, based on the cognitive radio guidance information on the display screen.

Moreover, in the present embodiment, the management server 6 may manage the received power averages of each location in the communication protocols by sequentially collecting the received power averages for each communication protocol per current location from each of the cognitive radio apparatuses 5. The management server 6 may provide the cognitive radio apparatuses 5 with the surrounding reception condition needed for the cognitive radio apparatuses 5 to generate the cognitive radio guidance information prompting selection guidance of the optimum communication protocol.

Moreover, in the present embodiment, the user of the cognitive radio apparatus 5 is prompted to move in order to select the communication protocol whose load to download via the network is lower, for example, based on the cognitive radio guidance information on the display screen. As a result, the load on the network of the entire communication protocol is alleviated, and the utilization efficiency of spatial frequency channels on a time axis or a frequency axis may be improved.

Moreover, in the present embodiment, when the cognitive radio apparatus 5 receives the surrounding reception condition, the cognitive radio guidance information generation part 22 acquires the predicted data rates for each communication protocol corresponding to the received power averages for each communication protocol corresponding to each location in the surrounding reception condition. The cognitive radio guidance information generation part 22 compares the predicted data rates each other for each communication protocol. Based on the comparison results, the cognitive radio guidance information generation part 22 displays, on the screen of the display part 16, the cognitive radio guidance information guiding selection of the optimum broadband communication protocol. For that reason, by viewing the cognitive radio guidance information, the user of the cognitive radio apparatus 5 may recognize the place and direction where the optimum broadband communication protocol of the predicted data rate may be obtained from the current location of the user by moving in the direction where the color on the display screen is darker, for example.

In the preceding embodiment, the cognitive radio apparatus 5 includes a configuration to generate cognitive radio guidance information for the user of the cognitive radio apparatus 5 to select the optimum broadband communication protocol based on the comparison results of the predicted data rates per communication protocol corresponding to the received power averages per communication protocol of each location. As another embodiment, the cognitive radio apparatus 5 may also include a configuration to add data specific costs of communication protocols corresponding to predicted data rates of communication protocols and generate the cognitive radio guidance information for the user of the cognitive radio apparatus 5 to select the optimum broadband communication protocol having better cost performance. As a result, the cognitive radio apparatus 5 may provide, to the user, cognitive radio guidance information for the user of the cognitive radio apparatus 5 to select the optimum communication protocol having better data specific cost performance. The cognitive radio apparatus 5 may also include a configuration to be enable selection as to whether predicted data rates or costs are preferably emphasized in the cognitive radio guidance information and to enable selection of cognitive radio guidance information emphasizing costs or cognitive radio guidance information emphasizing predicted data rates.

Further, in the preceding embodiment, the cognitive radio apparatus 5 includes a configuration to generate cognitive radio guidance information for the user of the cognitive radio apparatus 5 to select the optimum communication protocol based on the comparison results of the predicted data rates per communication protocol corresponding to the received power averages per communication protocol of each location. As another embodiment, the cognitive radio apparatus 5 may also include configuration to generate cognitive radio guidance information for the user of the cognitive radio apparatus 5 to select the optimum communication protocol of the received power averages simply based on the comparison results of the received power averages per communication protocol in each location.

Further, in the preceding embodiment, the cognitive radio apparatus 5 includes a configuration to notify the management server 6 of the current location communication quality information 30 at a periodic timing in periods when the cognitive radio apparatus 5 is not communicating or at a timing when the cognitive radio apparatus 5 issues a surrounding reception condition request. As another embodiment, for example, the cognitive radio apparatus 5 may also include a configuration to notify the management server 6 of the current location communication quality information 30 at a timing when the cognitive radio apparatus 5 initiates communication or at a timing when the cognitive radio apparatus 5 ends communication.

Further, in the preceding embodiment, there are two types of communication protocols: the communication protocol A and the communication protocol B. As another embodiment, the number of types of the communication protocols may also be three or more, so that the load on the user of the cognitive radio apparatus 5 for recognizing the optimum communication protocol may be significantly alleviated.

Further, in the preceding embodiment, the cognitive radio apparatus 5 uses the received power averages per radio channel for each communication protocol as the communication quality per current location. As another embodiment the same effects may be obtained even when the cognitive radio apparatus 5 uses channel estimates (propagation characteristics) per radio channel of the communication protocols.

Further, in the preceding embodiment, the cognitive radio apparatus 5 includes a configuration such that, when each of the cognitive radio apparatuses 5 in the cognitive communication protocol 1 requests the surrounding reception condition from the management server 6, the cognitive radio apparatus 5 notifies the management server 6 of the current location communication quality information 30 of the cognitive radio apparatus 5. As another embodiment, the cognitive radio apparatus 5 may also include a configuration such that the cognitive radio apparatus 5 may request the surrounding reception condition without notifying the management server 6 of the current location communication quality information 30.

Further, in the preceding embodiment, the cognitive communication protocol 1 has been taken as an example and described, but the same effects may also be obtained in a software communication protocol.

Further, in the preceding embodiment, the received power average acquisition part 18 of the cognitive radio apparatus 5 includes a configuration to acquire the received power averages of each radio channel in the communication protocol of the radio channels in use and to use the received power averages of each radio channel as the received power averages for each communication protocol to notify the management server 6 of the current location communication quality information 30. As another embodiment, in addition to the received power averages of each radio channel of the communication protocol of the radio channels in use, the received power average acquisition part 18 may also be configured to acquire the received power averages of each radio channel of another communicable communication protocol that is not in use and to use the received power averages of each radio channel as the received power averages for each communication protocol to notify the management server 6 of the current location communication quality information 30 together with the communication protocol that is in current use. In this case, the management server 6 may include a configuration to reflect the received power averages of each communication protocol corresponding to the same location because the management server 6 may obtain the received power averages of a plurality of communication protocols at certain locations.

Further, in the preceding embodiment, the management server 6 includes a configuration to sequentially collect the communication quality for each communication protocol per current location from each of the cognitive radio apparatuses 5. The management server 6 manages the communication quality of each location in the communication protocols. The management server 6 provides, to the cognitive radio apparatus 5 the surrounding reception condition needed for the cognitive radio apparatus 5 to generate the cognitive radio guidance information prompting selection guidance of the optimum communication protocol. As another embodiment, the management server 6 may also be configured to generate the cognitive radio guidance information so that the burden on the cognitive radio apparatus 5 that generates the cognitive radio guidance information may be significantly alleviated.

An embodiment of the present invention has been described above, but the scope of the technical ideas of the present invention is not limited to the embodiment, and the various embodiments are feasible as long as they do not depart from the range of the technical ideas set forth in the claims. Further, the effects described in the embodiment are not limited to such effects.

Further, of the various types of processing that have been described in the embodiment, all or part of processing described as being performed automatically may also of course be performed manually, and, conversely, all or part of processing described as being performed manually may also be performed automatically. Further, processing sequences, control sequences, specific names, and information including various data and parameters described in the embodiment may be appropriately altered except where otherwise indicated.

Further, each component of each device depicted in the drawings has been described functionally conceptually and does not invariably have to be configured physically as depicted in the drawings, and the specific configuration of each device is not intended to be limited to the configuration depicted in the drawings.

Moreover, all or any arbitrary part of each type of processing function that is performed by each device may also be executed on a central processing unit (CPU) (or a microcomputer such as a micro processing unit (MPU), or a micro controller unit (MCU)), or on a program that is analyzed and executed by the same CPU (or microcomputer such as an MPU or MCU) or on hardware resulting from wired logic.

Further, according to an aspect of the embodiments, any combinations of the described features, functions and/or operations may be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present inventions have been described in detail, it should be understood that the various changes, substitutions, and alterations could be made hereto without departing from the spirit and scope of the invention.

1. A cognitive radio system including at least one cognitive radio apparatus and a management server communicable with the at least one cognitive radio apparatus via a network, wherein,
the cognitive radio apparatus comprises:
a terminal communication part that selects a communication protocol for communication among a plurality of communication protocols,
a communication quality acquisition part that acquires a communication quality by receiving a current location of the cognitive radio apparatus and information of the selected communication protocol,
a communication quality notification part that notifies the management server via the terminal communication part of the current location of the cognitive radio apparatus and the communication quality, and wherein
the management server comprises:
a server communication part that communicates with the cognitive radio apparatus,
a communication quality collecting part that sequentially collects, from the cognitive radio apparatus via the server communication part, the current location of the cognitive radio apparatus and the communication quality,
a communication quality managing part that records and manages the communication quality collected by the communication quality collecting part with respect to each location and each communication protocol, and
an area communication condition providing part that provides an area communication condition to the cognitive radio apparatus, wherein the area communication condition includes any communication qualities of the current location of the cognitive radio apparatus and the area around the cognitive radio apparatus.

2. A cognitive radio apparatus including a display device, comprising:
a cognitive radio apparatus communication part that communicates, via a network, with a management server using one communication protocol among the plurality of different communication protocols including a plurality of access points in different communication protocols;
a communication quality acquisition part that acquires communication quality by receiving both a current location of the cognitive radio apparatus and information from the nearest access point to the cognitive radio apparatus of each communication protocol of the current location;
a communication quality notification part that notifies the management server, via the terminal communication part, of the current location of the cognitive radio apparatus and the communication quality for each communication protocol;
a command transmission part that transmits a command requesting a surrounding reception condition to the management server via the terminal communication part;
a surrounding condition reception part that receives the surrounding reception condition from the management server via the terminal communication part;
a cognitive radio guidance information generation part that generates cognitive radio guidance information guiding selection of a desirable communication protocol of each location in a surrounding region of the cognitive radio apparatus based on the surrounding reception condition;
a display control part that displays the cognitive radio guidance information on a screen of the display device;
a designation part that receives a user's designation to select the communication protocol which is to be used based on the cognitive radio guidance information displayed on the screen; and
a switching part that switches the communication protocol so as to use the selected communication protocol.

3. The cognitive radio apparatus according to claim 2, wherein
the cognitive radio guidance information generation part, upon receiving the surrounding reception condition from the management server side, generates cognitive radio guidance information guiding selection of the desirable broadband communication protocol of each location in the surrounding region based on predicted data rates per communication protocol with respect to the received power averages in the communication quality for each communication protocol of each location of the surrounding region in the surrounding reception condition.

4. The cognitive radio apparatus according to claim 2, wherein
the cognitive radio guidance information generation part, upon receiving the surrounding reception condition from the management server side, generates cognitive radio guidance information guiding selection of the desirable communication protocol of each location in the surrounding region based on both predicted data rates per communication protocol and data specific costs per communication protocol with respect to the received power averages in the communication quality for each communication protocol of each location of the surrounding region in the surrounding reception condition.

5. The cognitive radio apparatus according to claim 2, wherein
the communication quality managing part, when sequentially collecting, from the cognitive radio apparatus, the current location and the communication quality for each communication protocol of the cognitive radio apparatus which are acquired by the communication quality acquisition part from the cognitive radio apparatus, updates the communication quality for each communication protocol corresponding to the collected current location to the communication quality for each communication protocol being managed corresponding to the current location based on a last update time of the communication quality being managed corresponding to the current location.

6. The cognitive radio apparatus according to claim 3, wherein
the communication quality managing part, when sequentially collecting, from the cognitive radio apparatus, the current location and the communication quality for each communication protocol of the cognitive radio apparatus which are acquired by the communication quality acquisition part, updates the communication quality for each communication protocol corresponding to the collected current location to communication quality for each communication protocol being managed corresponding to the current location based on a last update time of the communication quality being managed corresponding to the current location.

7. The cognitive radio apparatus according to claim 4, wherein
the communication quality managing part, when sequentially collecting, from the cognitive radio apparatus, the current location and the communication quality for each communication protocol of the cognitive radio apparatus which are acquired by the communication quality acquisition part, updates the communication quality for each communication protocol unit corresponding to the collected current location to communication quality for each communication protocol being managed corresponding to the current location based on a last update time of the communication quality being managed corresponding to the current location.

8. The cognitive radio apparatus according to claim 2, wherein
the communication quality for each communication protocol of the current location of the cognitive radio apparatus which is acquired by the communication quality acquisition part includes communication quality of each radio channel in the communication protocol being in use by the cognitive radio apparatus.

9. The cognitive radio apparatus according to claim 3, wherein
the communication quality for each communication protocol unit of the current location of the cognitive radio apparatus which is acquired by the communication quality acquisition part includes communication quality of each radio channel in the communication protocol being in use by the cognitive radio apparatus.

10. The cognitive radio apparatus according to claim 4, wherein
the communication quality for each communication protocol of the current location of the cognitive radio apparatus which is acquired by the communication quality acquisition part includes communication quality of each radio channel in the communication protocol being used by the cognitive radio apparatus.

11. The cognitive radio apparatus according to claim 5, wherein
the communication quality for each communication protocol of the current location of the cognitive radio apparatus which is acquired by the communication quality acquisition part includes the communication quality of each radio channel in the communication protocol being used by the cognitive radio apparatus.

12. The cognitive radio apparatus according to claim 6, wherein
the communication quality for each communication protocol of the current location of the cognitive radio apparatus which is acquired by the communication quality acquisition part includes communication quality of each radio channel in the communication protocol being used by the cognitive radio apparatus.

13. The cognitive radio apparatus according to claim 7, wherein
the communication quality for each communication protocol of the current location of the cognitive radio apparatus which is acquired by the communication quality acquisition part includes communication quality of each radio channel in the communication protocol being used by the cognitive radio apparatus.

14. A management server that communicates with at least one cognitive radio apparatus via a network that includes a plurality of access points in different communication protocols, the management server comprising:
a server communication part that includes a display device and communicates with the cognitive radio apparatus that selects one communication protocol from a plurality of different communication protocols and performs cognitive radio;
a communication quality collecting part that sequentially receives, from the cognitive radio apparatus via the server communication part, the current location of the cognitive radio apparatus and the communication quality for each communication protocol and judges and collects the quality;
a communication quality managing part that records and manages the communication quality per location of the cognitive radio apparatus by the communication protocol based on the current location of the cognitive radio apparatus and the communication quality for each communication protocol collected by the communication quality collecting part; and
a surrounding reception condition providing part which, when receiving a given request command from the cognitive radio apparatus via the server communication part, reads, from the communication quality managing part, the surrounding region including the current location of the cognitive radio apparatus and the communication quality for each communication protocol corresponding to each location in the surrounding region and transmits, via the server communication part, to the cognitive radio apparatus that has transmitted the given request command, the surrounding region of the cognitive radio apparatus and the surrounding reception condition including the communication quality for each communication protocol that the surrounding reception condition providing part has read.

15. A computer-readable recording medium storing a computer program for causing a computer to function as a management server that includes a display device and communicates with at least one cognitive radio apparatus via a network that includes a plurality of access points of different communication protocols, the computer program for causing the computer to execute:
wirelessly communicating with the cognitive radio apparatus that selects one communication protocol from the plurality of different communication protocols and performs cognitive radio;
sequentially receiving, from the cognitive radio apparatus while wirelessly communicating, the current location of the cognitive radio apparatus and the communication quality for each communication protocol, and judging and collecting the communication quality;
recording and managing the communication quality per location of the cognitive radio apparatus based on the current location of the cognitive radio apparatus and the communication quality for each communication protocol collected at the communication quality collecting; and
when receiving a given request command from the cognitive radio apparatus at the wirelessly communicating, reading out, from the communication quality managing, the surrounding region including the current location of the cognitive radio apparatus and the communication quality for each communication protocol corresponding to each location in the surrounding region, and transmitting, while wirelessly communicating, to the cognitive radio apparatus that has transmitted the given request command, the surrounding region of the read cognitive radio apparatus and the surrounding reception condition including the communication quality for each communication protocol.

16. A computer-readable recording medium storing a computer program for causing a computer to function as a cognitive radio apparatus that includes a display device and communicates with each cognitive radio apparatus, the program being executed by the cognitive radio apparatus and a management server that communicates with each cognitive radio apparatus via a network that includes a plurality of access points per communication protocol, the computer program for causing the computer to execute:
wirelessly communicating with the management server by selecting one communication protocol from a plurality of different communication protocols;
selecting one communication protocol from the plurality of different communication protocols, receiving a current location of the cognitive radio apparatus and information from the nearest access point to the cognitive radio apparatus by the communication protocol of the current location by the one communication protocol, and obtaining a communication quality;
sequentially informing the management server, during the wirelessly communicating, of the current location of the cognitive radio apparatus and the communication quality for each communication protocol;
transmitting a command requesting a surrounding reception condition to the management server during the wirelessly communicating;
receiving the surrounding reception condition from the management server during the wirelessly communicating;
generating cognitive radio guidance information guiding selection of a desirable communication protocol of each location in a surrounding region of the cognitive radio apparatus based on the surrounding reception condition;
displaying the cognitive radio guidance information on a screen of the display device;
selecting the communication protocol which is to be used from the cognitive radio guidance information displayed on the screen; and
switching the communication protocol so as to use the selected communication protocol.

17. A method of causing a computer to function as a management server that includes a display device and communicates with at least one cognitive radio apparatus via a network that includes a plurality of access points in different communication protocols, the method comprising:
wirelessly communicating with the cognitive radio apparatus that selects one communication protocol from the plurality of different communication protocols and performs cognitive radio;
sequentially receiving, from the cognitive radio apparatus during the server communicating, the current location of the cognitive radio apparatus and the communication quality for each communication protocol, and judging and collecting the communication quality;
recording and managing the communication quality per location of the cognitive radio apparatus by the communication protocol based on the current location of the cognitive radio apparatus and the communication quality for each communication protocol, which have been collected during the communication quality collecting; and
when receiving a given request command from the cognitive radio apparatus at the server communicating, reading out, from the communication quality managing, the surrounding region including the current location of the cognitive radio apparatus and the communication quality for each communication protocol corresponding to each location in the surrounding region, and transmitting, during the server communicating, to the cognitive radio apparatus that has transmitted the given request command, the surrounding region of the read cognitive radio apparatus and the surrounding reception condition including the communication quality for each communication protocol.

18. A method of causing a computer to function as a cognitive radio apparatus that includes a display device and communicates with each cognitive radio apparatus, the method being executed by the cognitive radio apparatus and a management server that communicates with each cognitive radio apparatus via a network that includes a plurality of access points per communication protocol, the method comprising:
wirelessly communicating with the management server by selecting one communication protocol from a plurality of different communication protocols;
selecting one communication protocol from the plurality of different communication protocols, receiving a current location of the cognitive radio apparatus and information from the nearest access point to the cognitive radio apparatus by the communication protocol of the current location by the one communication protocol, and obtaining a communication quality;
sequentially informing the management server during the wirelessly communicating of the current location of the cognitive radio apparatus and the communication quality for each communication protocol;
transmitting a command requesting a surrounding reception condition to the management server during the wirelessly communicating;
receiving the surrounding reception condition from the management server during the wirelessly communicating;
generating cognitive radio guidance information guiding selection of an desirable communication protocol of each location in a surrounding region of the cognitive radio apparatus based on the surrounding reception condition;
displaying the cognitive radio guidance information on a screen of the display device;
selecting the communication protocol which is to be used from the cognitive radio guidance information displayed on the screen; and
switching the communication protocol so as to use the selected communication protocol.

19. A management server that includes a display device and communicates with at least one cognitive radio apparatus via a network that includes a plurality of access points per communication protocol, the management server comprising:
a server communication part that selects one communication protocol from a plurality of different communication protocols and is wirelessly communicable with the cognitive radio apparatus performing cognitive radio;
a communication quality collecting part that sequentially receives, from the cognitive radio apparatus in the server communication part, the current location of the cognitive radio apparatus and the communication quality for each communication protocol, and judging and collecting the communication quality;
a communication quality managing part that records and manages the communication quality per location of the cognitive radio apparatus by the communication protocol based on the current location of the cognitive radio apparatus and the communication quality for each communication protocol, which have been collected by the communication quality collecting part;
a cognitive radio guidance information generation part that, when receiving a given request command from the cognitive radio apparatus from the server communication part, reads out, from the communication quality managing part, the surrounding region including the current location of the cognitive radio apparatus and the communication quality for each communication protocol corresponding to each location in the surrounding region, and generates the cognitive radio guidance information based on the surrounding region of the read cognitive radio apparatus and the surrounding reception condition including the communication quality for each communication protocol; and
a cognitive radio guidance information providing part that transmits the cognitive radio guidance information generated by the cognitive radio guidance information generation part to the cognitive radio apparatus transmitting part the given request command via the server communication part.

20. A cognitive radio apparatus that includes a display device and communicates with a management server via a network that includes a plurality of access points in different communication protocols, the cognitive radio apparatus comprising:
a terminal communication part that is wirelessly communicable with the management server by selecting one communication protocol from the plurality of different communication protocols;
a communication quality acquisition part that receives a current location of the cognitive radio apparatus and information from the nearest access point to the cognitive radio apparatus for each communication protocol of the current location, and acquiring a communication quality;
a communication quality notification part that informs the management server via the terminal communication part of the current location and the communication quality;
a command transmission part that transmits, to the management server via the terminal communication part, a command requesting cognitive radio guidance information guiding selection of a desirable communication protocol of each location in a surrounding region of the cognitive radio apparatus;
a cognitive radio guidance information reception part that receives the cognitive radio guidance information from the management server via the terminal communication part;
a display control part that displays the cognitive radio guidance information received by the cognitive radio guidance information reception part on a screen of the display device;
a designation part that selects the communication protocol to be used from the cognitive radio guidance information displayed on the screen; and
a switching part that switches the communication protocol to the selected communication protocol.
